(19) United States
(12) Patent Application Publication
(10) Pub. No.: US 2018/0239509 A1
(43) Pub. Date: Aug. 23, 2018

(54) PRE-INTERACTION CONTEXT ASSOCIATED WITH GESTURE AND TOUCH INTERACTIONS

(71) Applicant: Microsoft Technology Licensing, LLC, Redmond, WA (US)

(72) Inventors: Kenneth P. Hinckley, Redmond, WA (US); Michel Pahud, Kirkland, WA (US); William Arthur Stewart Buxton, Toronto (CA); Seongkook Heo, Daejeon (KR)

(73) Assignee: Microsoft Technology Licensing, LLC, Redmond, WA (US)

(21) Appl. No.: 15/437,374

(22) Filed: Feb. 20, 2017

(51) Int. Cl. G06F 3/0488; G06F 3/044

(52) U.S. Cl. CPC G06F 3/0488; G06F 3/044; G06F 2203/04104; G06F 2203/04108; G06F 2203/04808; G06F 2203/04806

(57) ABSTRACT

Use of pre-interaction context associated with gesture and touch interactions is provided. A user interface is configured to receive an interaction. A touch or gesture input may be received from a user via a touchscreen. Prior to receiving an interaction on the user interface from the user, pre-interaction context is detected. Based on the pre-interaction context, the user's interaction with the user interface is interpreted and the interaction is provided on the user interface.

### BACKGROUND

Input capabilities of computing devices vary greatly based on the types of input devices associated with the computing device. The input capabilities are generally characterized by a state-transition model that provides various approaches for categorizing the types of inputs received by the computing device. Specifically, these state-transition models provide discrete transitions between each of the states in response to receiving an interaction. Conventionally, computing input devices in general are characterized by a three-state model. For touch screens in particular, the three state-transition model includes an “Out of Range” state when the finger is not in contact with the touch screen, and a second “Dragging” state when the finger touches down (drags) on the touch screen. A third state, wherein a tracking symbol moves on the screen without otherwise triggering interactions with the system (“Tracking”), is not sensed by most touch screens (however, on touchscreens with integrated pressure sensing capabilities—or suitable proxies such as capacitive area sensing—a light touch may be mapped to “Tracking” and a touch with increased pressure to “Dragging”). In the above example, the touch screen interface cannot sense the presence of the finger(s) and, as such, does not and cannot provide an effect in the Out-of-Range state, and provides a direct-manipulation effect associated with the Dragging state, but no third state is available except through cumbersome gestures or mode-switches (such as the tap-and-a-half gesture employed by some touchpads). As such, the state-transition model of most modern mobile devices is driven almost entirely by the location, timing, and dynamic evolution of touch gestures after the finger comes into contact with the computing device.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Aspects of systems and methods for the use of pre-interaction context associated with gesture and touch interactions are discussed herein. The system is configured to provide a user interface to receive an interaction. For example, the system is operable to receive touch or gesture input from the user via a touch screen. Prior to receiving an interaction on the touch screen interface from the user, the system detects pre-interaction context. Further, the system is configured to detect an interaction. Based upon the pre-interaction context, the system interprets the user's interaction with the user interface. Thereafter, the system is configured to provide the interaction on the user interface. Accordingly, by using the pre-interaction context, the system improves the recognition accuracy of the interactions, simplifies or extends the state transition models, improves response time, and reduces latency to initiate actions because the pre-interaction context allows the user's intent to be determined earlier than traditional touch interactions that must rely entirely on movement while the finger is in contact with the screen.

Examples are implemented as a computer process, a computing system, or as an article of manufacture such as a device, computer program product, or computer readable medium. According to an aspect, the computer program product is a computer storage medium readable by a computer system and encodes a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of a system for providing pre-interaction context associated with gesture and touch interactions;

FIGS. 2A-2B are illustrations of example graphical user interfaces implementing pre-interaction context associated with gesture and touch interactions;

FIG. 3A-3E are illustrations of example graphical user interfaces implementing pre-interaction context associated with gesture and touch interactions;

FIGS. 4A-4F are illustrations of example graphical user interfaces implementing pre-interaction context associated with gesture and touch interactions;

FIG. 5 is an illustration of an example graphical user interface implementing pre-interaction context associated with gesture and touch interactions;

FIG. 6 is an illustration of an example graphical user interface implementing pre-interaction context associated with gesture and touch interactions;

FIGS. 7A-7B are illustrations of example graphical user interfaces implementing pre-interaction context associated with gesture and touch interactions;

FIG. 8 is an illustration of an example graphical user interface implementing pre-interaction context associated with gesture and touch interactions;

FIGS. 9A-9B are illustrations of example graphical user interfaces implementing pre-interaction context associated with gesture and touch interactions;

FIGS. 10A-10B are illustrations of example graphical user interfaces implementing pre-interaction context associated with gesture and touch interactions;

FIGS. 11A-11D are illustrations of example graphical user interfaces implementing pre-interaction context associated with gesture and touch interactions;

FIG. 12 is a flow chart showing general stages involved in an example method implementing pre-interaction context associated with gesture and touch interactions;

FIG. 13 is a block diagram illustrating example physical components of a computing device;

FIGS. 14A and 14B are block diagrams of a mobile computing device; and

FIG. 15 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of systems and methods for the use of pre-interaction context associated with gesture and touch interactions are discussed herein. The system is configured to provide a user interface to receive an interaction. For example, the system is operable to receive touch or gesture input from the user via a touch screen. Prior to the receiving an interaction on the user interface from the user, the system detects pre-interaction context. Further, the system is configured to detect an interaction. Based upon the pre-interaction context, the system interprets the user's interaction with the user interface. Thereafter, the system is configured to provide the interaction on the user interface. Accordingly, by using the pre-interaction context, the system improves the recognition accuracy of the interactions, simplifies or expands on the state transition models, improves response time, and reduces latency to initiate actions because the pre-interaction context allows the user's intent to be determined earlier than traditional touch interactions that must rely entirely on movement while the finger is in contact with the screen.

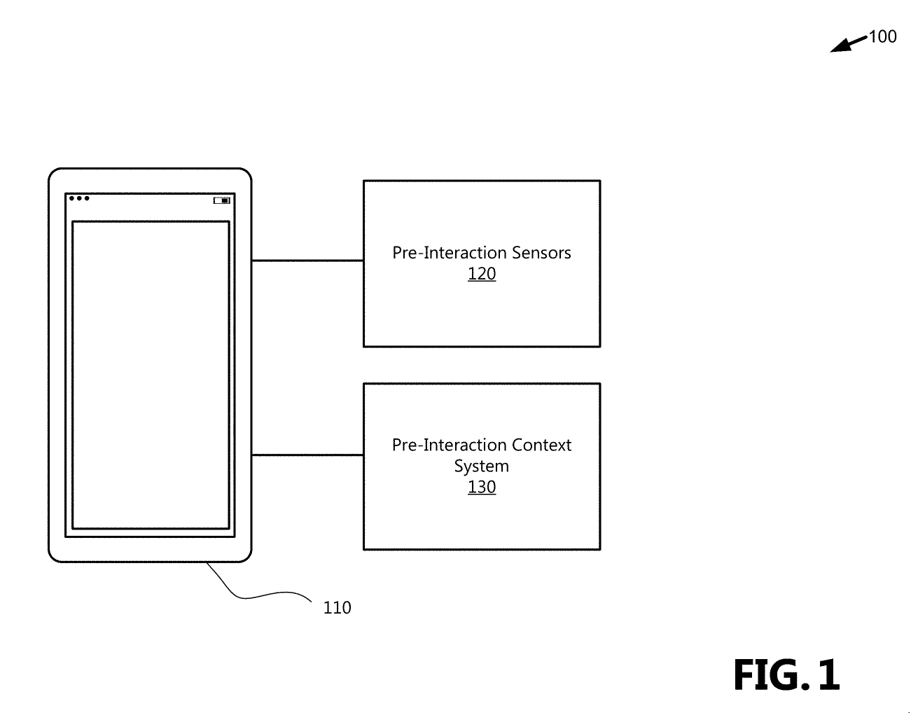

FIG. 1 is a block diagram of a system for providing pre-interaction context associated with gesture and touch interactions. As illustrated, the example environment 100 includes a computing device 110, including pre-interaction sensors 120. The computing device 110 is in communication with a pre-interaction context system 130 for detecting pre-interaction context associated with a gesture or touch interaction.

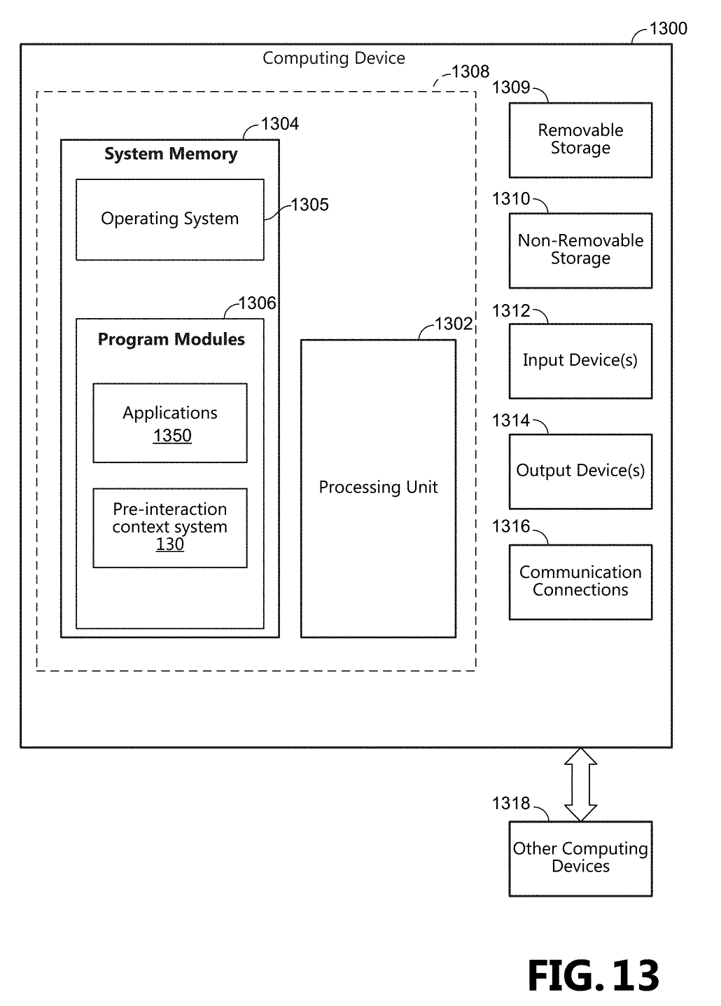

The computing device 110 is illustrative of a variety of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. The hardware of these computing systems is discussed in greater detail in regard to FIGS. 13, 14A, 14B, and 15. In various aspects, the computing device 110 is accessible locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

The pre-interaction sensors 120 are configured to detect information regarding gestures and touch interactions. According to one aspect, the pre-interaction sensors 120 are embodied in a self-capacitance touchscreen with a 16×9 matrix of sensors. More specifically, the touchscreen senses 14-bit capacitance for each cell of the matrix, with a 120 Hz sampling rate. As such, the presence of a fingertip can be sensed approximately 35 mm above the screen, but the range depends on total capacitance (e.g., a flat palm can be sensed approximately 5 cm away). Further, the user's grip can be sensed close to the edges.

Pre-interaction context system 130 is configured to identify pre-interaction context via the pre-interaction sensors 120. The pre-interaction context system 130 is configured to interpret touch or gesture based on the pre-interaction context. More specifically, based upon the pre-interaction context, the pre-interaction context system 130 interprets the user's interaction with the user interface, which allows the pre-interaction context system 130 to implement enhanced functionalities including anticipatory reactions, retroactive interpretations, and hybrid hover+touch gestures.

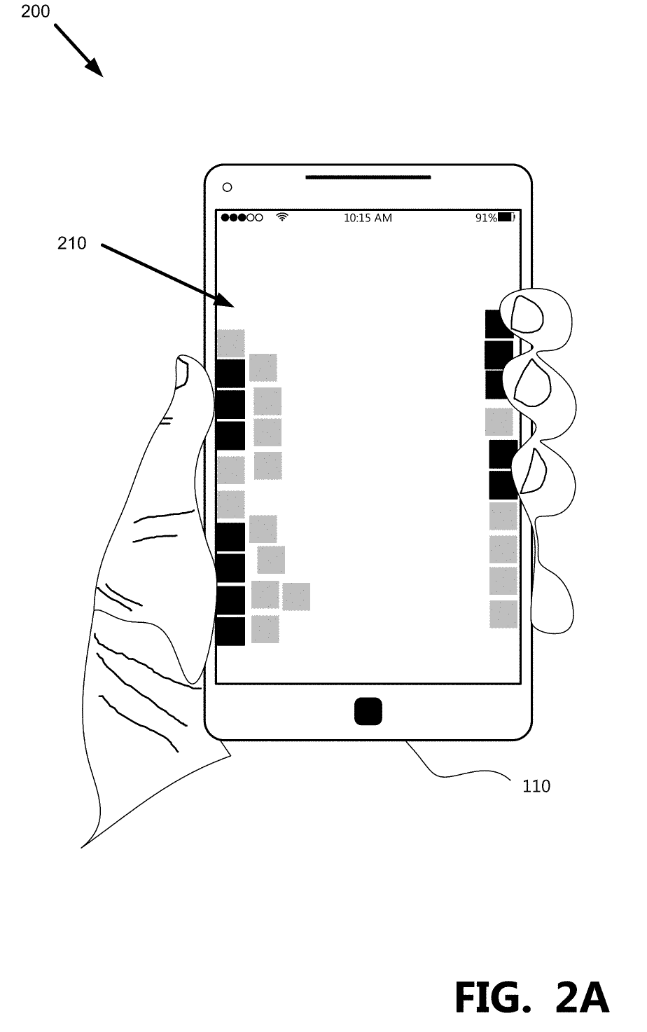

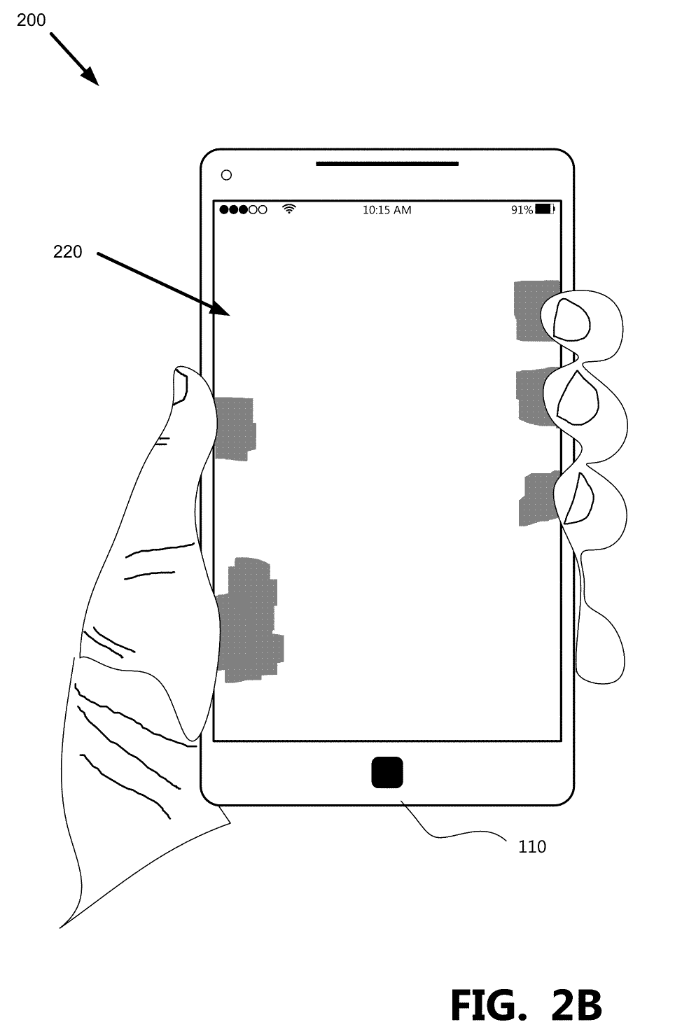

FIGS. 2A-2B are illustrations of example graphical user interfaces 200 implementing pre-interaction context associated with gesture and touch interactions. As illustrated in FIG. 2A, the example graphical user interface 200 depicts an image of raw sensor data 210 showing the variations in capacitance values on the user interface caused by the user's hand. Further, the raw sensor data 210 may be interpolated to provide more definition of the user's hand. As illustrated in FIG. 2B, the example graphical user interface 200 depicts an image of interpolated sensor data 220 showing the relative positions of the user's hand.

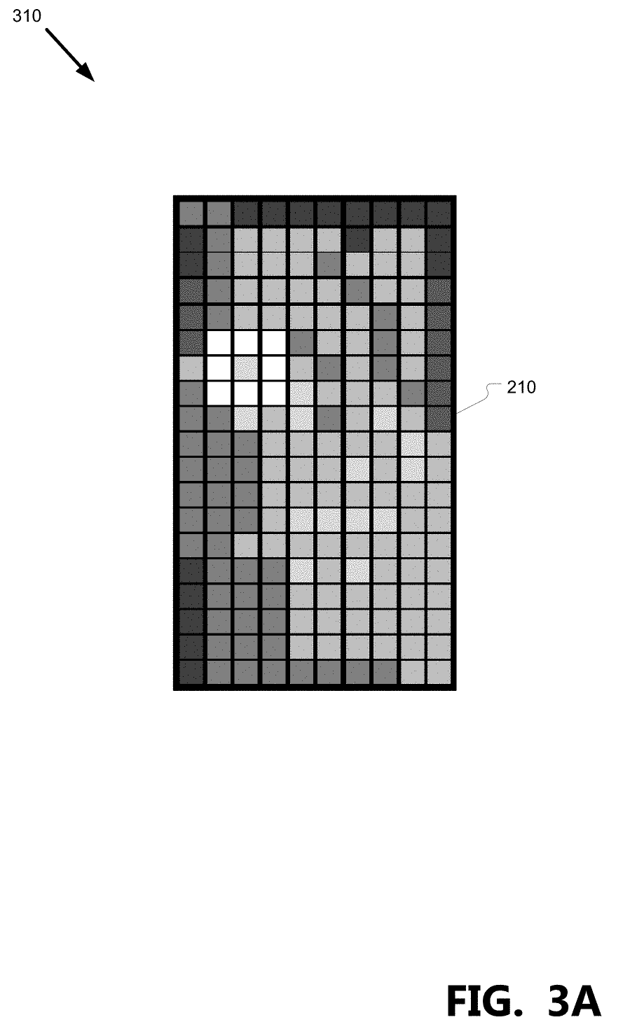

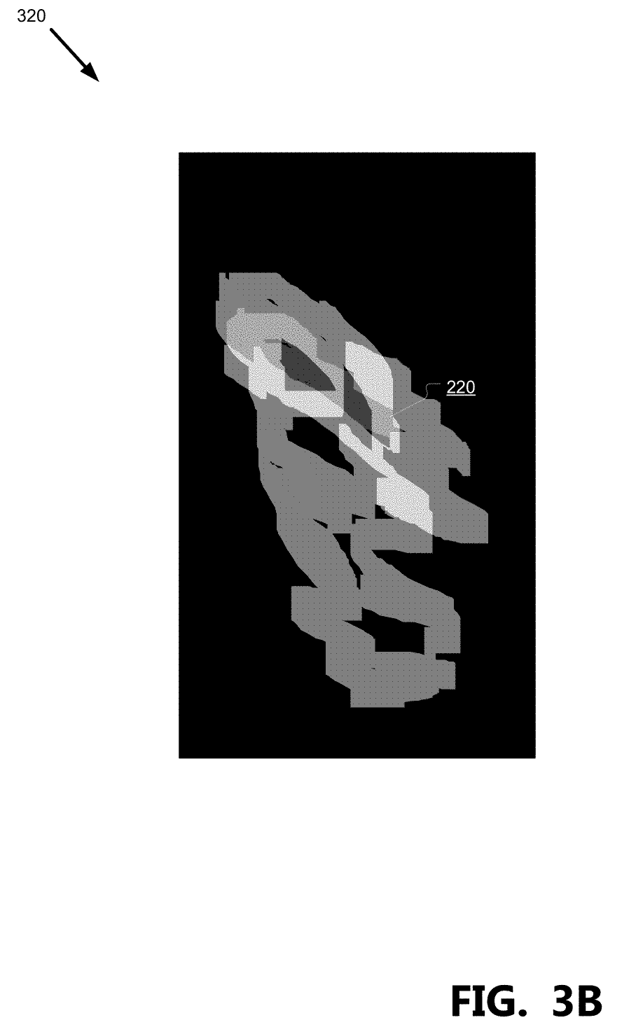

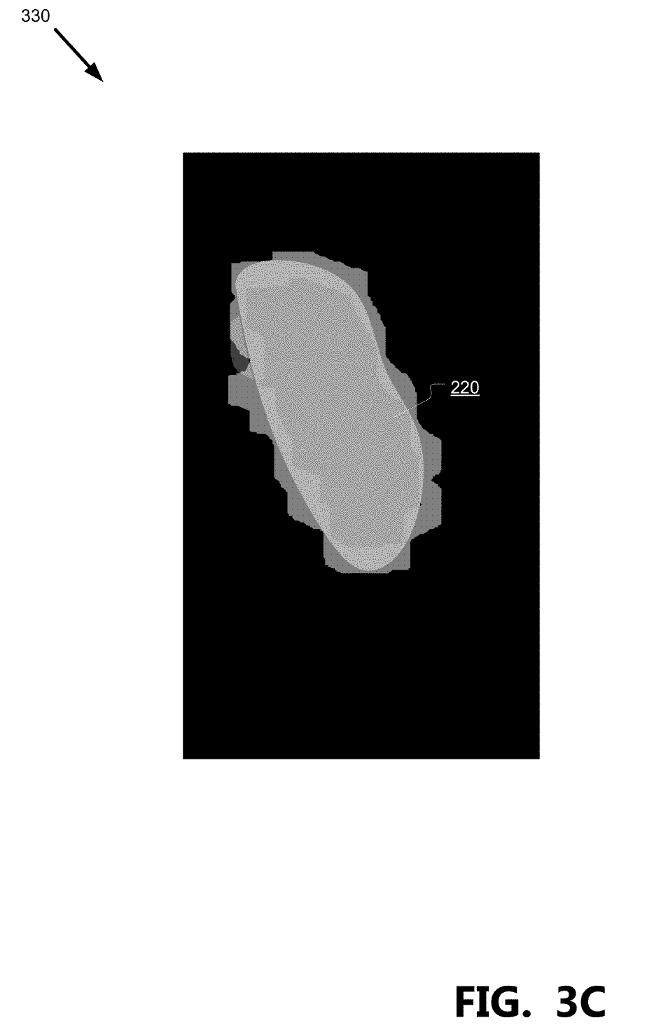

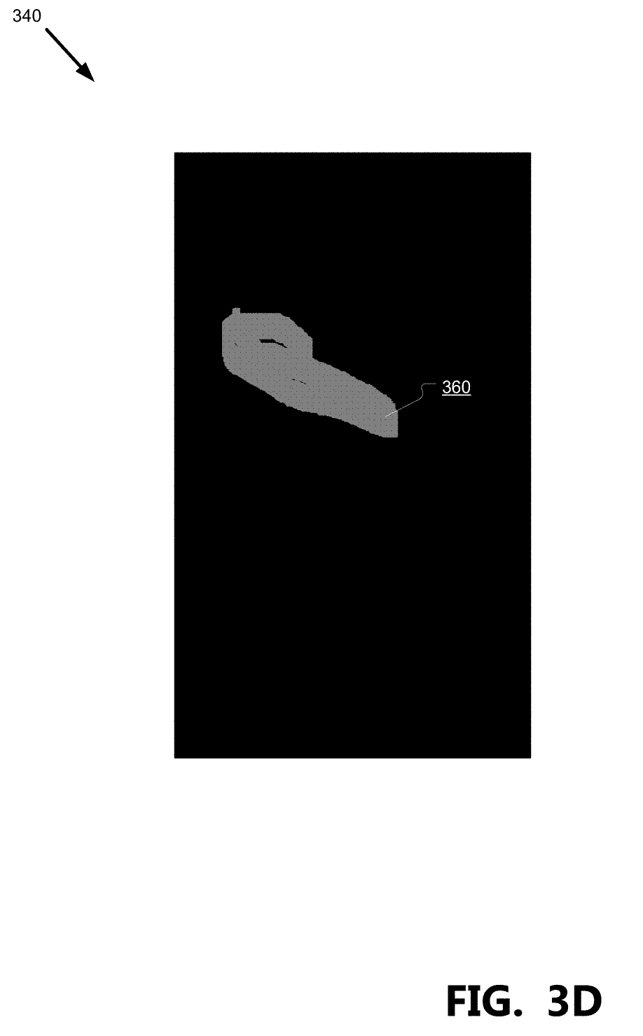

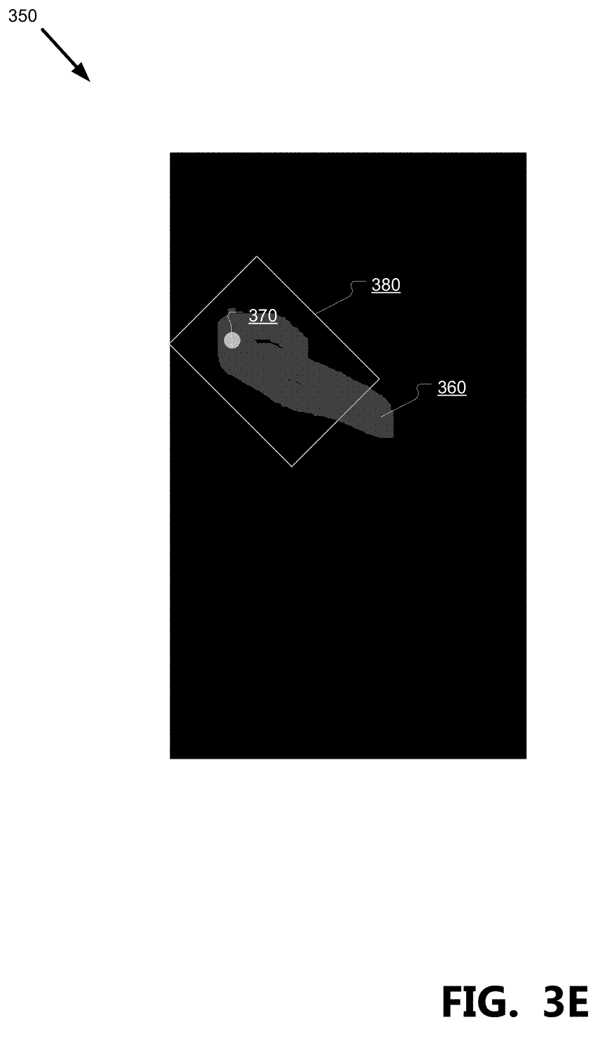

FIGS. 3A-3E are illustrations of example graphical user interfaces 300 implementing pre-interaction context associated with gesture and touch interactions. In many cases, the pre-interaction context associated with gesture and touch interactions is used in detecting the trajectory of an approaching finger. Accordingly, it is often helpful to identify the fingertip of the approaching finger in order to provide the most accurate results.

According to one example, as illustrated in FIGS. 3A-3E, the pre-interaction context system 130 uses a five-step pipeline to identify a single finger approaching the screen. According to other aspects, the pre-interaction context system 130 is configured to detect and identify multiple fingers approaching the screen, including two or more fingers or a finger/thumb interaction. In response to the pre-interaction context system 130 detecting the approach of the finger, the pre-interaction context system 310 captures the raw sensor data 210. FIG. 3A illustrates an example image 310 of the raw sensor data 210 showing the variations in capacitance values. When multiple fingers are interacting with the interface, the raw sensor data 210 shows multiple locations of variations in the capacitance values, which correspond to each of the multiple fingers. While the discussions below demonstrate an example pipeline associated with an interaction from a single finger, the pipeline is also operable to detect and identify each of the multiple fingers.

The raw sensor data 210 is interpolated to 180×320 using the Lanzos 4 algorithm to provide more data points associated with the approaching finger. FIG. 3B illustrates an example image 320 of the interpolated sensor data 220.

A first fixed threshold is applied to the interpolated sensor data 220 to remove noise of the capacitance sensor. FIG. 3C illustrates an example image 330 of the interpolated sensor data 220 after removing at least a portion of the noise.

Further, the pre-interaction context system 130 also increases the contrast of the image and applies a second threshold, which allows the fingertip region 360 of the finger to be isolated. FIG. 3D illustrates an example image 340 of the fingertip region 360.

Using the isolated fingertip region, the pre-interaction context system is operable to identify the fingertip. According to one aspect, the fingertip is detected by finding the local maxima in the fingertip region 360. In one example, the local maxima are identified by moving a 6.5×4.6 mm window by 3.3 mm (horizontally) and 2.3 mm (vertically). If there are multiple local maxima within 1.5 mm, the pre-interaction context system 130 combines the multiple local maxima into single maxima at the center point. A 5 mm radius circular mask may also be applied around each local maxima. Based on the calculations, the pre-interaction context system 130 identifies the fingertip as the highest maxima. However, if the local maxima fall at a screen edge, the pre-interaction context system 130 identifies the local maxima as part of the grip and disregards the local maxima. As shown in the example image 350 of FIG. 3E, the local maxima identifying the fingertip is depicted by a point 370 within the fingertip region 360.

Further, the pre-interaction context system 130 is operable to distinguish between a thumb and a finger. According to one aspect, the pre-interaction context system 130 calculates the orientation of the fingertip to identify whether the fingertip is a thumb or a finger. According to another aspect, the pre-interaction context system 130 is configured to use machine learning to distinguish between fingers. In one example, the pre-interaction context system 130 determines the tilt of the finger by applying a bounding box 380 around the fingertip and sizing the bounding box 380 to include the fingertip. The aspect ratio of the bounding box 380 indicates whether the finger is upright or oblique. Further, the yaw angle is identified by rotating the bounding box 380 to find the angle with the least brightness change along the fingertip blob. As shown in FIG. 3E, the bounding box 380 identifies the orientation and the angle of the finger interaction. The pre-interaction context system 130 combines these metrics to determine if the fingertip is most likely a thumb (of the hand holding the device) or a finger from the other hand. For example, if the fingertip is oblique and came from the same side that the user is gripping, then the pre-interaction context system 130 determines the fingertip is from a thumb. Otherwise the pre-interaction context system 130 determines the fingertip is from a finger. According to one aspect, the pre-interaction context system 130 is configured to enhance the detection of a fingertip based on the correlation of sensors associated with the computing to provide contextual information (e.g., orientation).

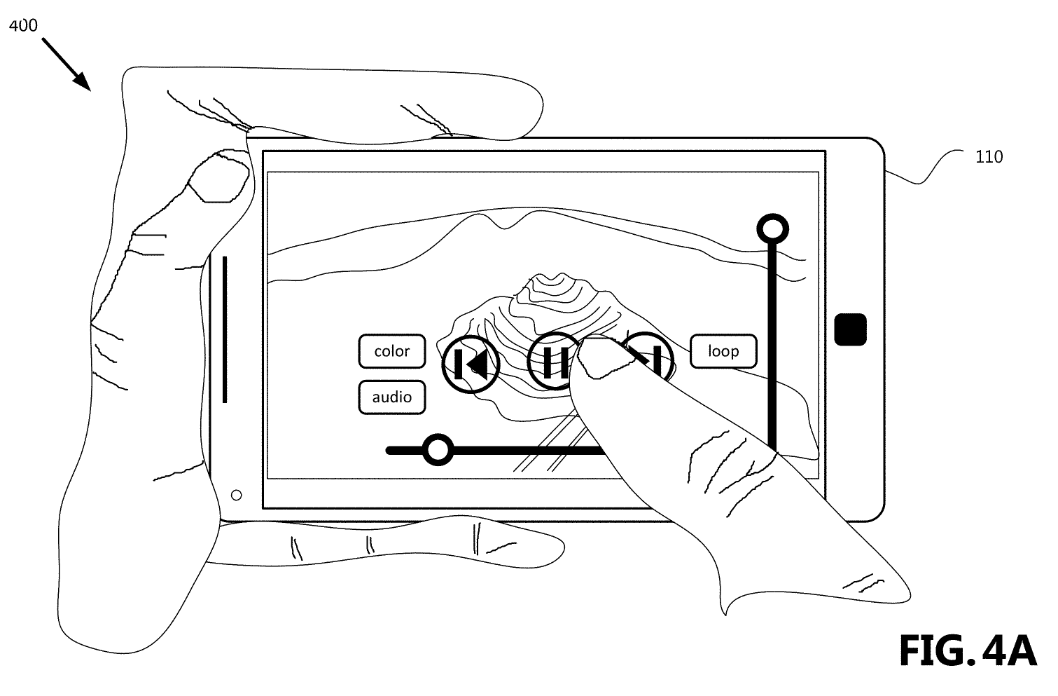

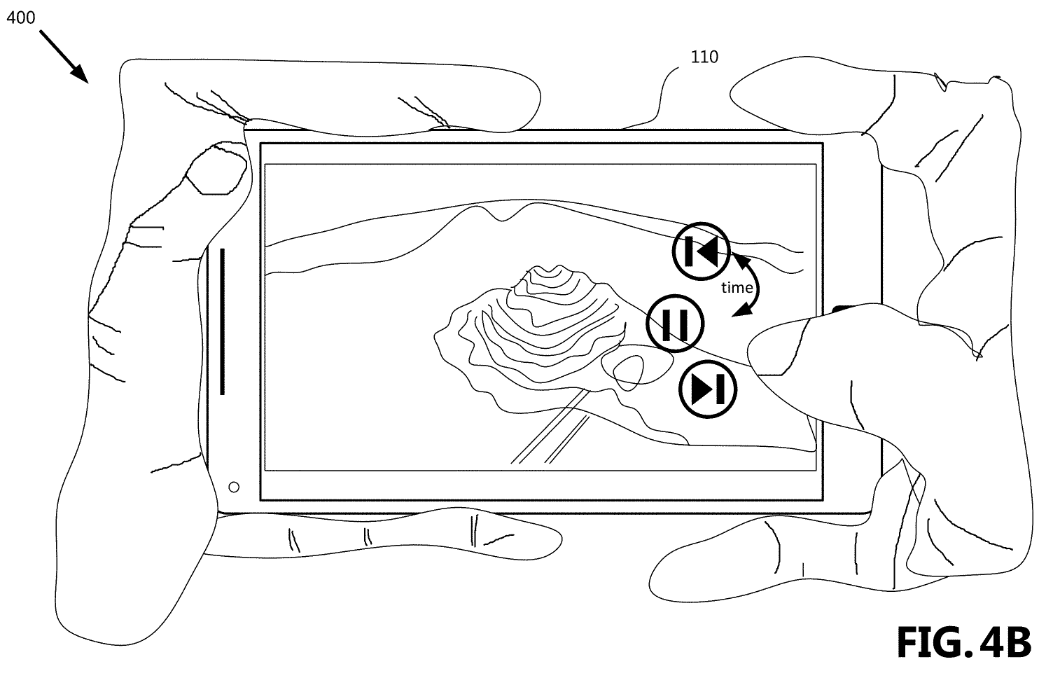

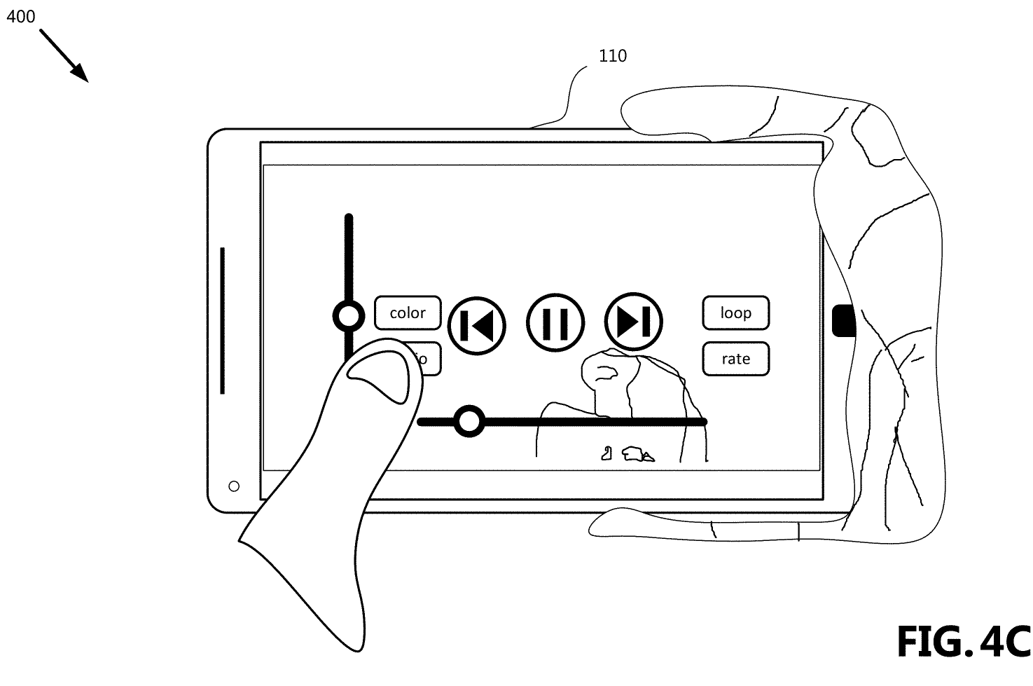

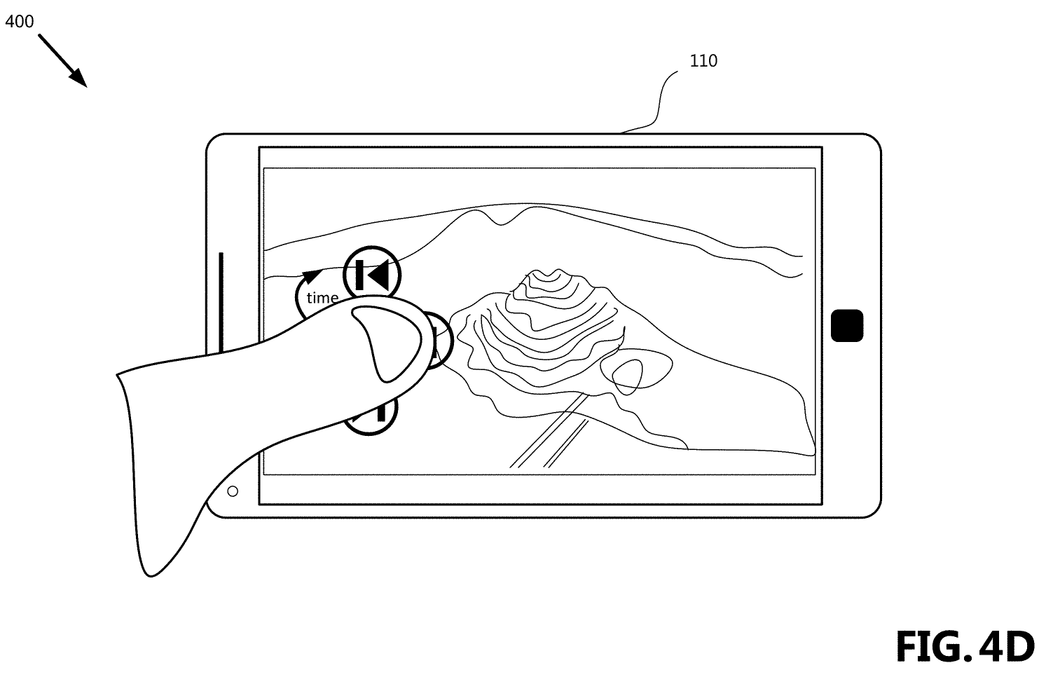

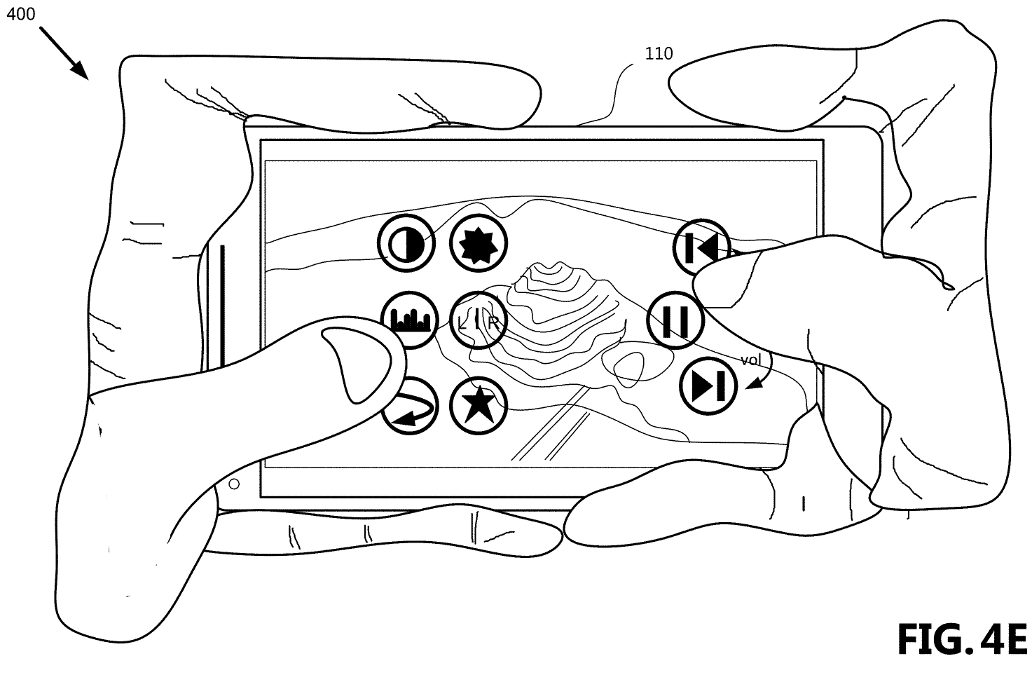

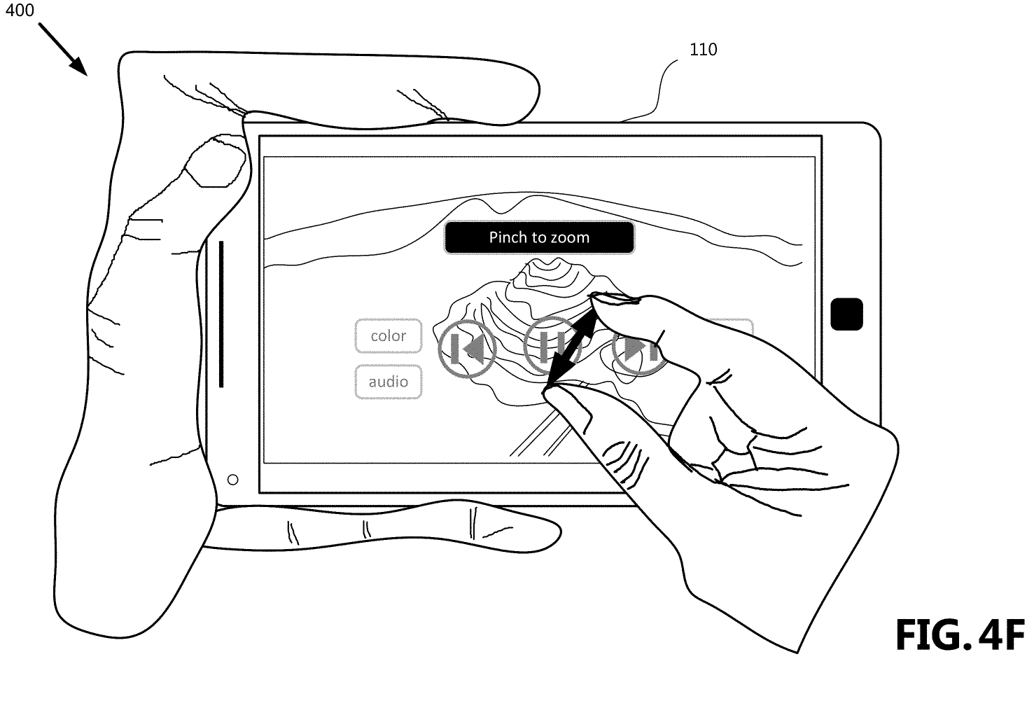

FIGS. 4A-F are illustrations of example graphical user interfaces 400 implementing pre-interaction context associated with gesture and touch interactions. The pre-interaction context system 130 may also be used to provide interaction techniques for anticipatory functionality that proactively adapts the interface to suit the context of interaction, such as the current grip and the approach of the fingers. In other words, as one or more fingers enter the proximity of the touchscreen, the pre-interaction context system 130 presents an appropriate interface based on the current grip, the number of fingers, and/or the approach trajectory of the finger(s).

According to one aspect, the pre-interaction context system 130 presents the interactive interface in an appropriate manner on demand. For example, the pre-interaction context system senses when a finger approaches the touchscreen and provides the interactive interface “just in time.” Generally, when the user is not interacting with the touchscreen, the user interface does not provide a visible interface. However, as soon as the pre-interaction context system 130 detects a hand approaching, it responds by presenting an appropriate interface promptly. In one example of a video player application, the pre-interaction context system 130 provides a fade-in transition designed to draw the user's eye to the core playback controls: play/pause, rewind, and fast-forward. When the finger moves out of range, the video player's controls fade from focus.

According to one aspect, the pre-interaction context system 130 presents the interactive interface in an appropriate location on demand. In one example, when the user grips the phone in one hand and approaches the central areas of the screen with the index finger of the opposite hand, the pre-interaction context system 130 fades in the default full set of controls. In one example, the fade-in animation emphasizes the core playback controls, which is accomplished by fading in the core playback controls before ancillary controls. Afterwards, the core playback controls are then surrounded by other ancillary controls, including a vertical slider for volume control for example. Further, providing the full set of controls based on the circumstances because an index finger poised above the screen is nimble enough to reach a variety of locations. Furthermore, the two-handed usage posture indicates the user is engaged with the system and likely has more cognitive and motor resources available.

In another example, when the user grips the device in a single hand and reaches over the screen with a thumb, the pre-interaction context system fades in the interface specifically designed for one-handed use. More particularly, because it is hard to reach the center of the screen with the thumb, the pre-interaction context system 130 fades in the controls closer to the edge in a fan-shaped layout that suits the natural movement of the thumb. It should also be recognized that the controls are rendered based on the user's grip. In FIG. 4B, the pre-interaction context system renders a version for the right hand. In FIG. 4D, the pre-interaction context system 130 renders a version for the left. Furthermore, because one-handed interaction is less dexterous and more suited to casual activity, the pre-interaction context system 130 renders only a subset of the default interface, which includes the core playback controls.

According to one aspect, the pre-interaction context system presents the interactive interface with additional functionalities when multiple fingers are used. In one example, the pre-interaction context system 130 determines the user is using two thumbs to interact with the touchscreen. When the user reaches onto the screen with a second thumb, the pre-interaction context system supplements the one-handed controls with an additional set of advanced options. FIG. 4E illustrates an example additional set of advanced options that are presented to the user.

In another example, the pre-interaction context system 130 determines the user is attempting to use two fingers to interact with the touchscreen. When the pre-interaction context system 130 determines that the multiple fingers are approaching in a particular posture, the pre-interaction context system fades out the interface and presents a gestural guide. For example, in FIG. 4F the pre-interaction context system 130 determines the multiple fingers are arranged in a posture similar to a pinch-to-zoom gesture. In response, the pre-interaction context system 130 displays a gestural guide providing information how to perform the pinch-to-zoom gesture. It should be recognized that the gestural guide may provide other information regarding potential gestures.

In one example, the pre-interaction context system 130 uses the approach direction of the finger to present the interactive interface. More specifically, the approach trajectory also refines the presentation of controls on the touchscreen based on the bimanual grip with the index finger. For example, the presentation of the vertical volume slider based on the grip and figure(s) used. FIG. 4A illustrates that the volume slider appears to the right of the main controls when the index finger approaches from the right. FIG. 4C illustrates that the volume slider appears to the left of the main controls when the grip and finger(s) are indicative of left-handed use. Further, according to other aspects, the pre-interaction context system 130 is configured to utilize contextual information provided by sensors associated with the computing device to identify the orientation of the computing device (e.g., landscape, portrait, flat, at an angle, etc.).

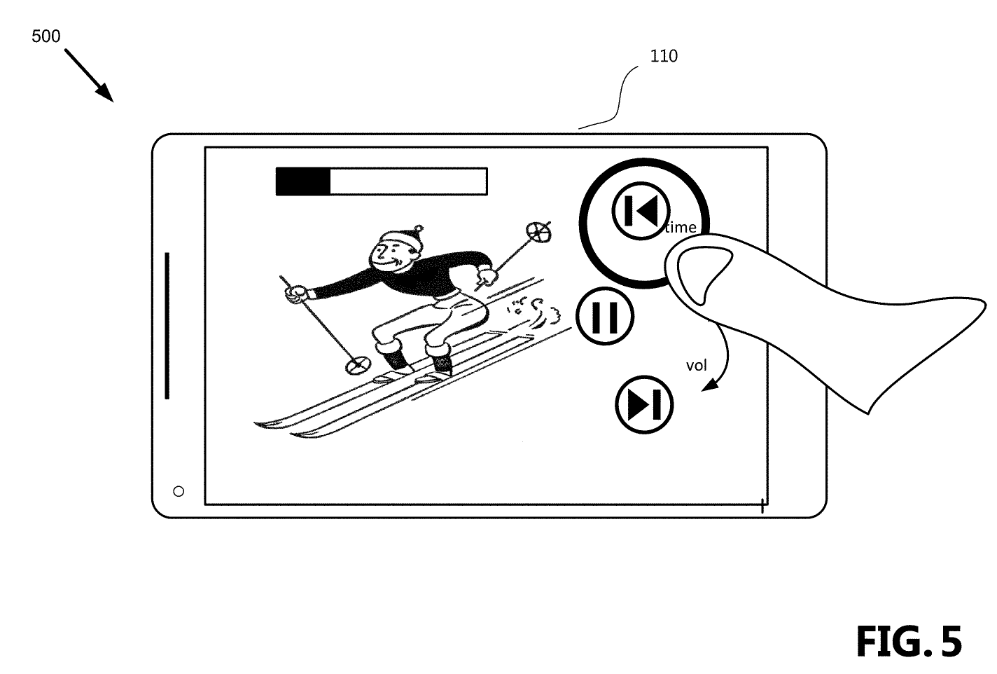

FIG. 5 is an illustration of an example graphical user interface 500 implementing pre-interaction context associated with gesture and touch interactions. According to one aspect, the pre-interaction context system 130 provides controls optimized for the current grip, the number of fingers, and/or the approach trajectory of the finger(s). In one example, the pre-interaction context system 130 provides linear sliding controls optimized for interactions via the user's index finger. However, in the illustrated example, the pre-interaction context system translates the linear sliding controls into dial controls optimized for interactions via the user's thumb, which may allow the user to scrub through the timeline or adjust the volume. Further, the controls may be presented via animations associated with the gesture and touch interactions. For example, when the one-handed controls animate onto the screen, they follow a path that mimics the finger approach.

According to one aspect, the pre-interaction context system 130 provides the optimized controls at a readily accessible location for receiving interactions from the identified finger approach. For example, the optimized controls are located at a comfortable distance from the edge of the screen for receiving an interaction from the thumb. In one example, the pre-interaction context system provides the optimized controls at fixed locations relative to the interacting finger, thereby conserving processing requirements for predicting the landing position from the early portion of a movement trajectory. However, in either situation, the location of the optimized controls is presented at predictable locations such that the users may anticipate the location of the controls without full aid of the graphical user interface.

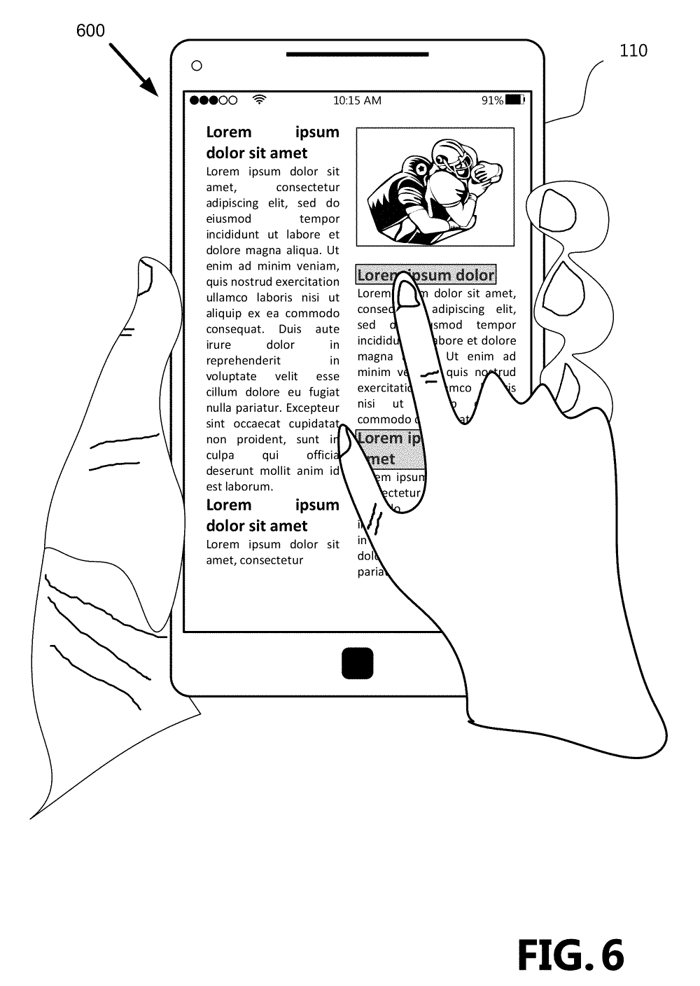

FIG. 6 is an illustration of an example graphical user interface 600 implementing pre-interaction context associated with gesture and touch interactions. More specifically, the example graphical user interface 600 uses pre-interaction context to provide an uncluttered experience.

Conventionally, web pages employ various visual effects to provide an indication of actionable content, including use of underlining links, highlighting hashtags, and overlaying playback controls on interactive media such as videos or podcasts. Showing all of these effects adds clutter to the content itself. Unfortunately, omitting these effects can leave the user uncertain of which content is interactive.

According to one aspect, implementation of the pre-interaction context system 130 allows the user interface to provide an uncluttered experience. In other words, the user is able to experience a clean version of the content for consumption. However, when the user's finger(s) approach the screen, the hyperlinks and playback controls reveal themselves. In one example, the effects are provided in a rich way that gradually trails off from the contours of the finger, thumb, or even the whole hand waving above the screen. This feathering of the interactive effects allows the user to quickly see many actionable items, rather than visiting them one-by-one. Furthermore, this emphasizes the items nearby, while more distant items are hinted at in a subtle manner. This leads to gradual revelation of the effects, in accordance with proximity to the hand, rather than having individual elements visually pop in and out in a way that would be distracting. In one example, the feathering is implemented by alpha-blending an overlay image, containing the various visual effects, that is displayed when a finger comes into proximity, and transitions from fully transparent to fully visible as the hand moves closer to the screen.

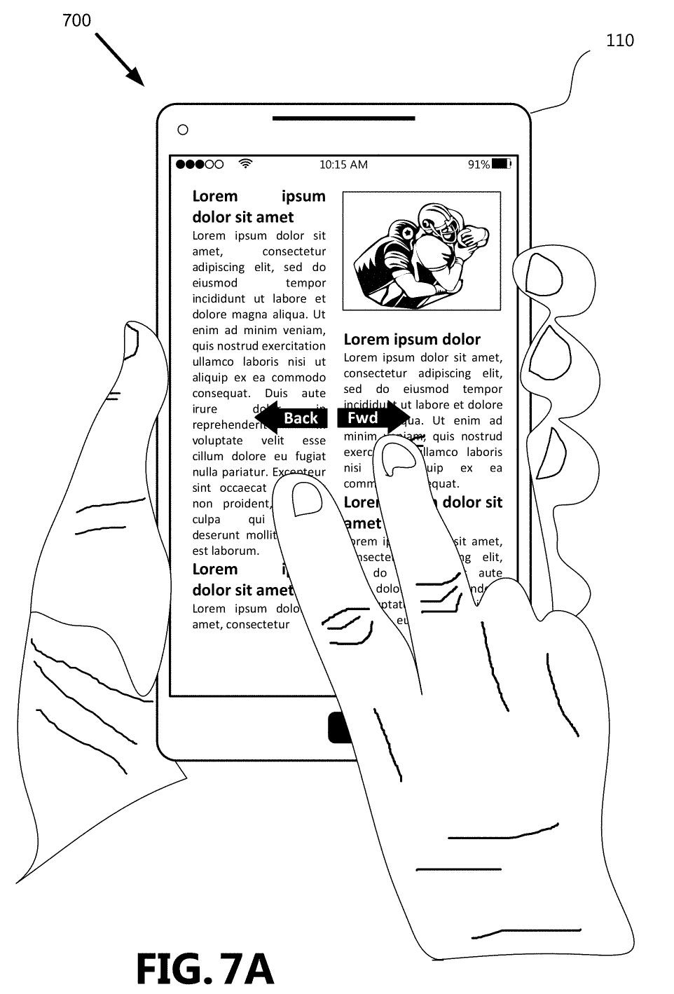

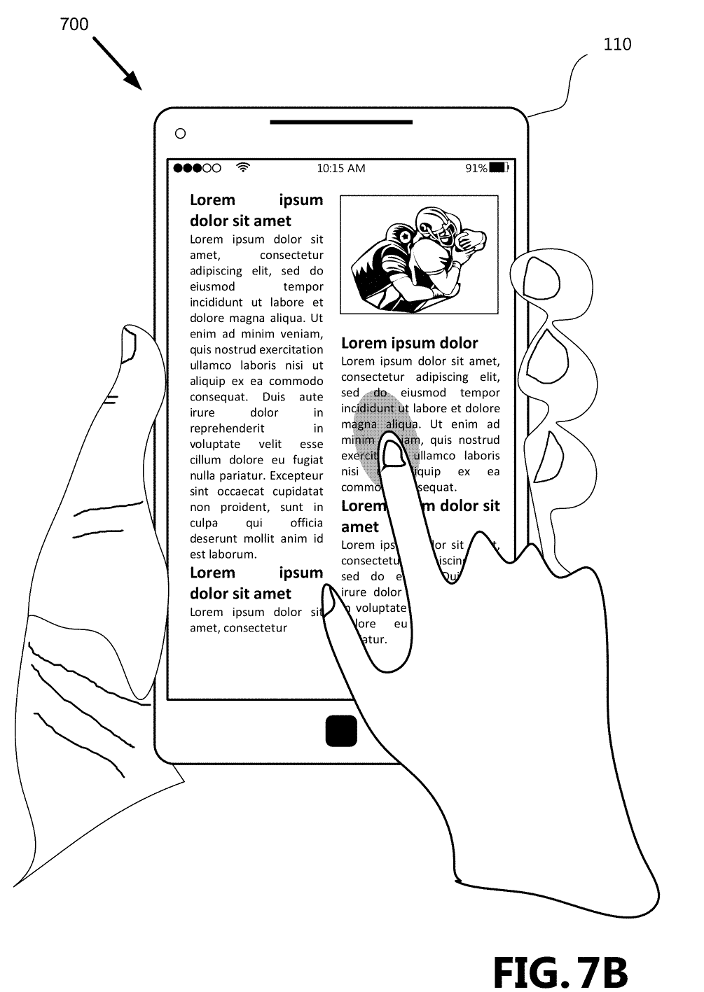

FIGS. 7A-7B are illustrations of example graphical user interfaces 700 implementing pre-interaction context associated with gesture and touch interactions. More specifically, the example graphical user interfaces 700 use pre-interaction context to provide a self-revelation of gesture guides for multi-touch interactions. According to one aspect, the graphical user interface supports a two-finger tabbing gesture to slide back and forth between browsing tabs. In FIG. 7A, the self-revelation of gesture guides fades in a gesture overlay when it senses two fingers side-by-side in the appropriate posture. At the same time the visual effects in the user interface fades out. According to one aspect, the graphical user interface supports a collaboration mode where the finger contour can be used to highlight portions of the content. The highlighted portion of the content provides the user with the ability to easily refer to areas of a workspace. As illustrated in FIG. 7B, the highlight is provided as a finger contour to expressively signify the collaborative content, which may be provided in color (e.g., yellow) to further emphasize the highlight.

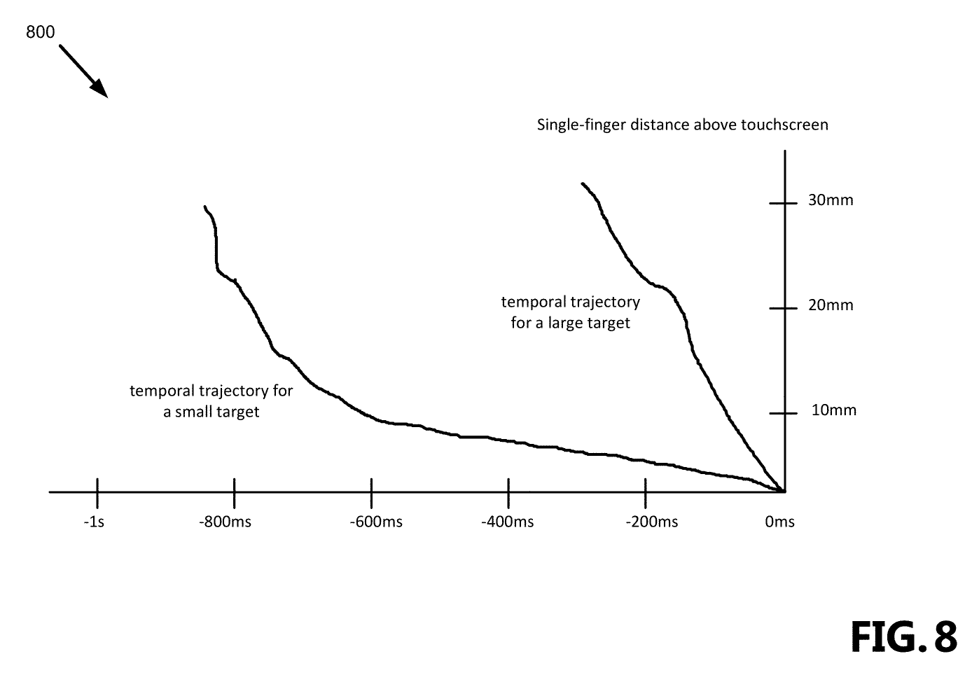

FIG. 8 is an illustration of an example chart 800 implementing pre-interaction context associated with gesture and touch interactions. Pre-interaction context can also provide as a back-channel that augments touch events. More specifically, the pre-interaction context system is retroactively applied to the interaction to identify the approach trajectory at the time of the contact to glean more information about the interaction. This allows pre-interaction context to be used in the background to support the foreground action. However, these retroactive techniques produce no effect if the user does not complete the movement and make contact with the touchscreen. The retroactive technique provides additional insight into the approach trajectory that may help to better reveal the user's intent. The illustrated chart 800 identifies that users generally make fine adjustments to the trajectory prior to tapping on small targets, but simply tap on larger targets. Thus, based on the observed approach trajectory, the pre-interaction context system 130 is operable to provide additional information regarding the user's intended target.

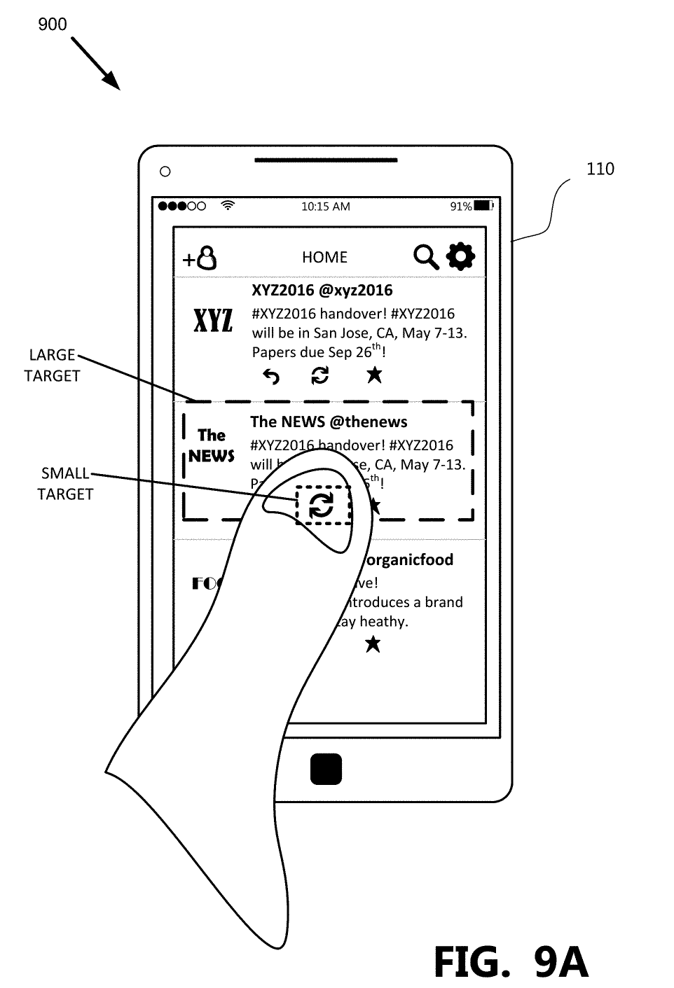

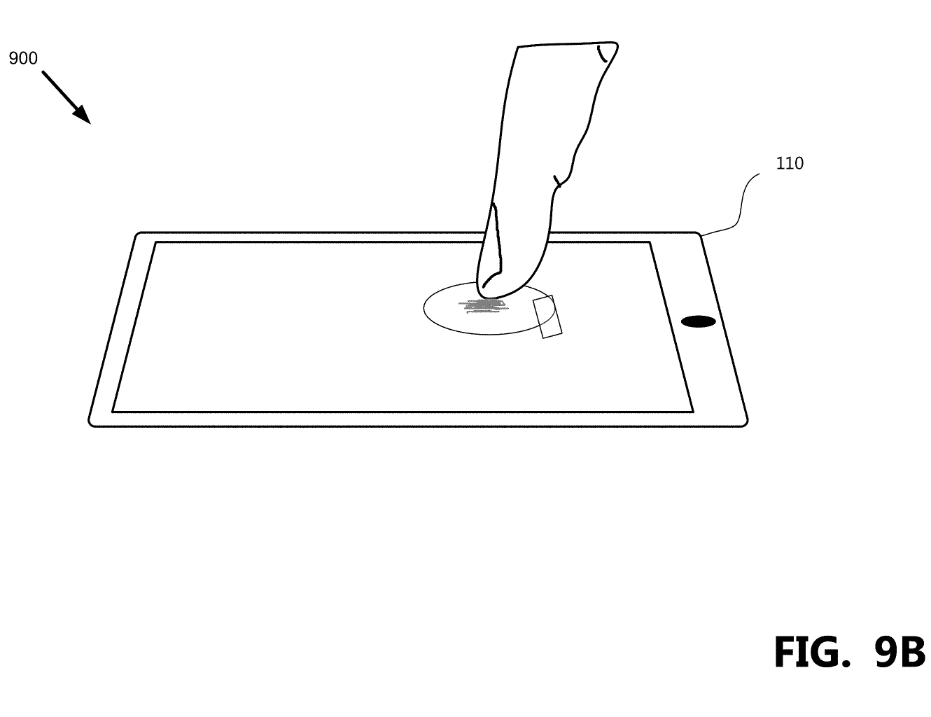

FIGS. 9A-9B are illustrations of example graphical user interfaces 900 implementing pre-interaction context associated with gesture and touch interactions. As discussed in FIG. 8, the pre-interaction context system 130 is operable to provide additional information regarding the user's intended target. According to one aspect, the pre-interaction context system 130 is operable to distinguish between ballistic and fine taps. Typically, user interfaces may provide multiple targets within a relatively condensed area, which may cause the user to accidently tap one target instead of another. In one example, the user taps on a large target, this imprecise, ballistic action may just happen to land on one of the small targets, triggering an accidental and unwanted action. In another example, the user attempts to tap on the very small target, but may miss the small target by a few pixels and land on another target, which was not the intended operation.

According to one aspect, the pre-interaction context system 130 inspects the in-air approach trajectory upon contact with the touchscreen. If the finger motion was purely ballistic, the pre-interaction context system dispatches the tap event to the large target (FIG. 9A). If the motion appears to include fine adjustments, it is instead dispatched to a smaller candidate target if one lies within a radius (e.g., 7.7 mm) of the finger-down event (FIG. 9B). More specifically, in one example, the pre-interaction context system 130 detects fine taps by identifying when the touch trajectory with an altitude under 10 mm above the screen, and within 15 mm of the touch-down location, for the 250 ms before the finger makes contact. Alternatively, the pre-interaction context system 130 may be configured to detect the touch dynamic and trajectory optimized for one-handed interactions or optimized for a particular user. Further, in one example, the pre-interaction context system 130 is configured to detect contextual information associated with the computing device (whether the computing device is being held, whether the environment is stable) via one or more sensors in the computing device.

According to another aspect, the pre-interaction context system 130 is operable to distinguish between a flick and a select interaction upon contact with the touchscreen. More specifically, the pre-interaction context system 130 interprets an approach trajectory with a ballistic swiping motion as a flick. Whereas, the pre-interaction context system 130 interprets an approach trajectory for a fine tap as a selection of content. Accordingly, the pre-interaction context system 130 can immediately trigger scrolling or text selection without the need to require a tedious tap-and-hold interaction.

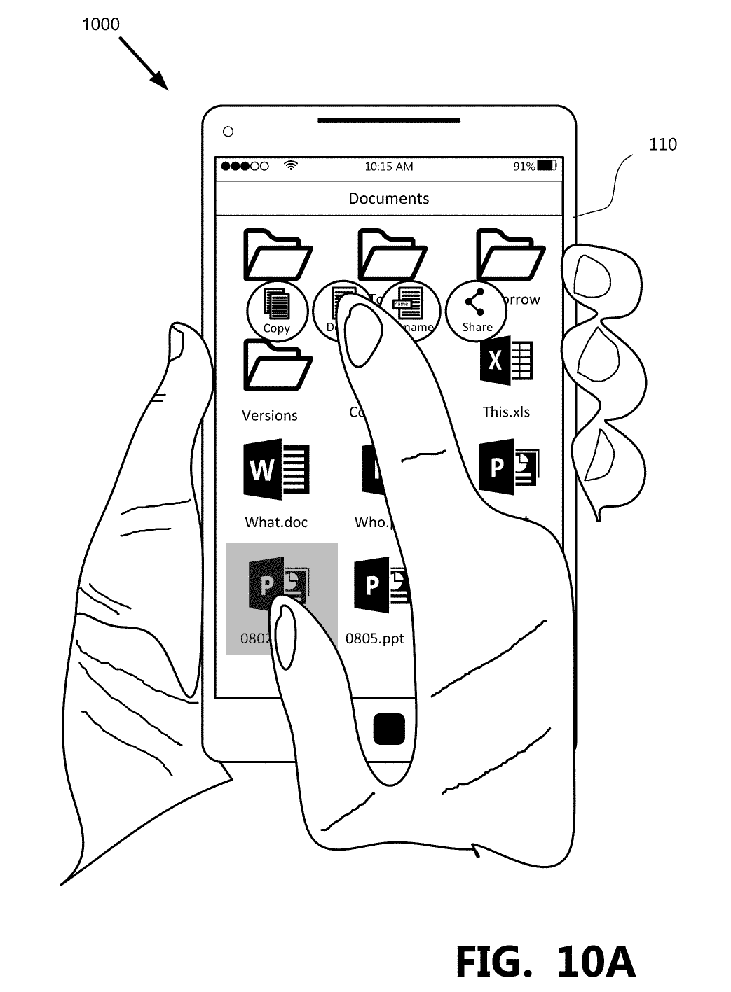

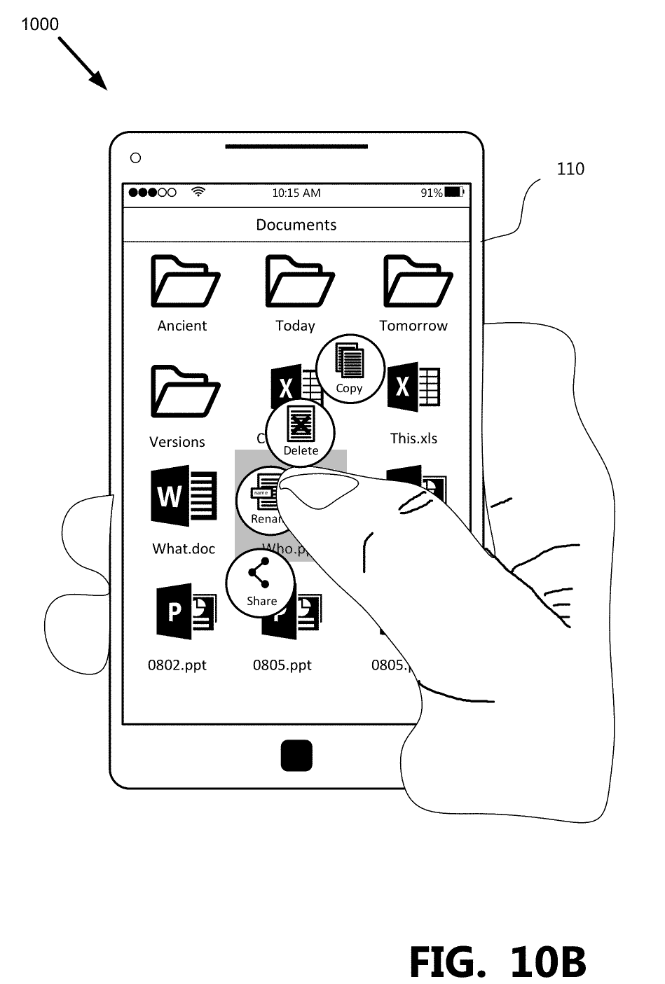

FIGS. 10A-10B are illustrations of example graphical user interfaces 1000 implementing pre-interaction context associated with gesture and touch interactions. More specifically, the pre-interaction context system is operable to recognize hybrid touch+hover gestures, which combine on-screen touch with simultaneous in-air gesture.

According to one aspect, the pre-interaction context system is operable to be utilized for implementing a hybrid touch+hover gesture that integrates selection of the desired object with the activation of other functionalities, which are articulated as a single compound task. As demonstrated in FIG. 10A, the user first selects the desired file by holding a thumb on it, while simultaneously bringing a second finger into range. This summons the object's menu. Furthermore, since the system knows where the user's finger is, it can invoke the menu at a convenient location, directly under the finger. The opacity of the menu is proportional to the finger's altitude above the display. The user then completes the transaction by touching down on the desired command. Alternatively, the user can cancel the action simply by lifting the finger. As a result, the implementation of hybrid touch+hover gestures eliminates the necessity for providing conventional tap-and-hold gestures by providing a selection and action into a single compound task that provides functionality in a convenient interaction.

According to another aspect, the pre-interaction context system 130 identifies when the user is interacting one-handedly. When a thumb is being used for interaction with the touchscreen, the user taps-and-holds on the desired icon with the thumb, which activates the menu. As illustrated in FIG. 10B, the pre-interaction context system 130 presents the menu with a fan-shaped layout that arcs in a direction appropriate to the approach of the thumb.

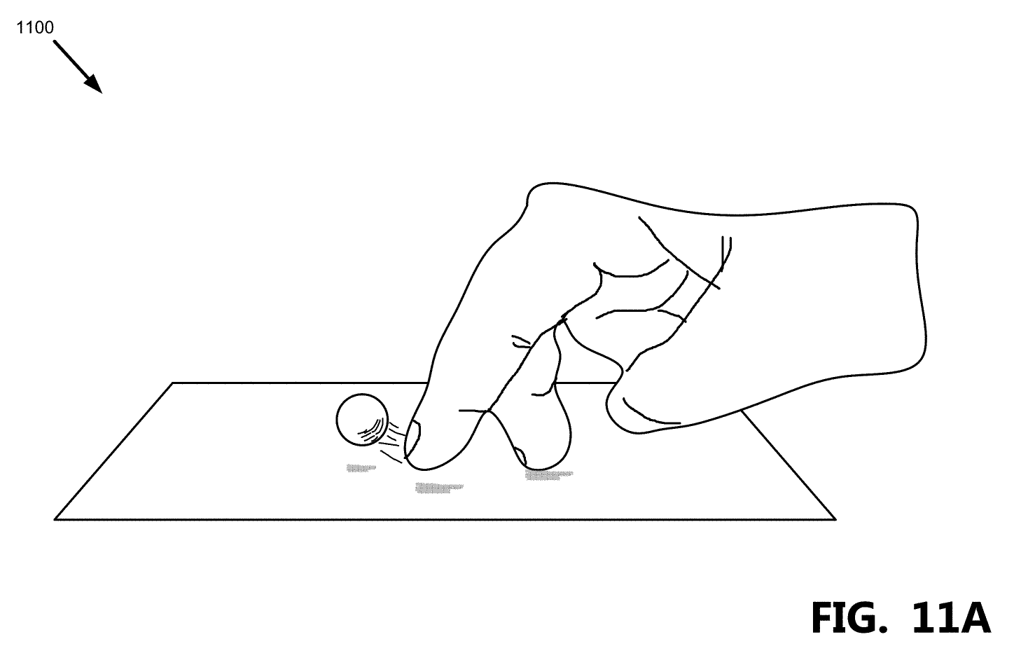

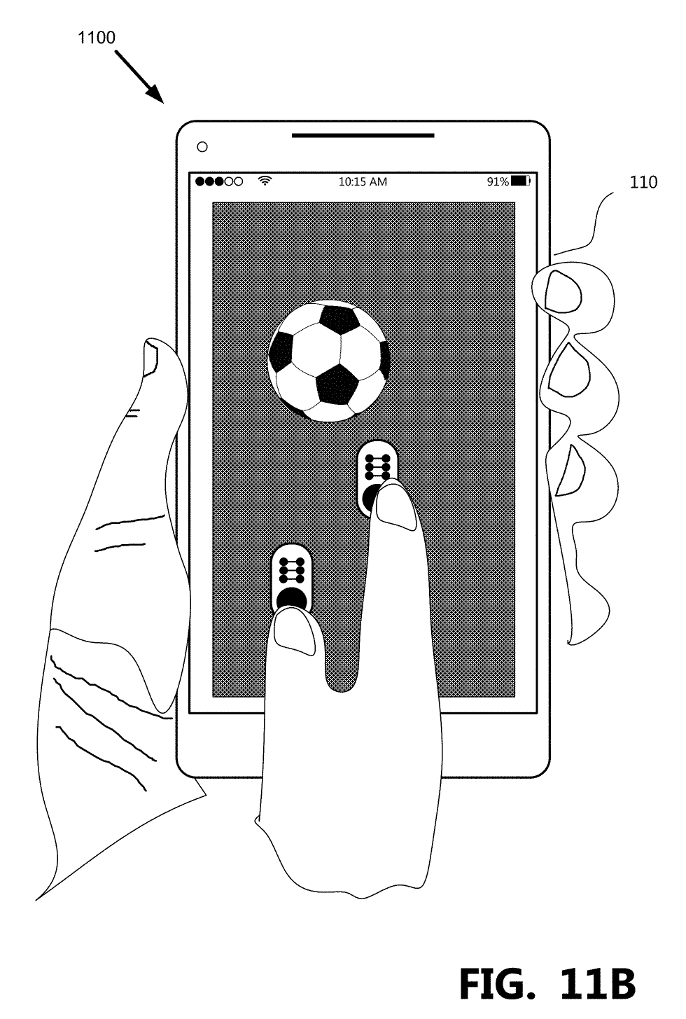

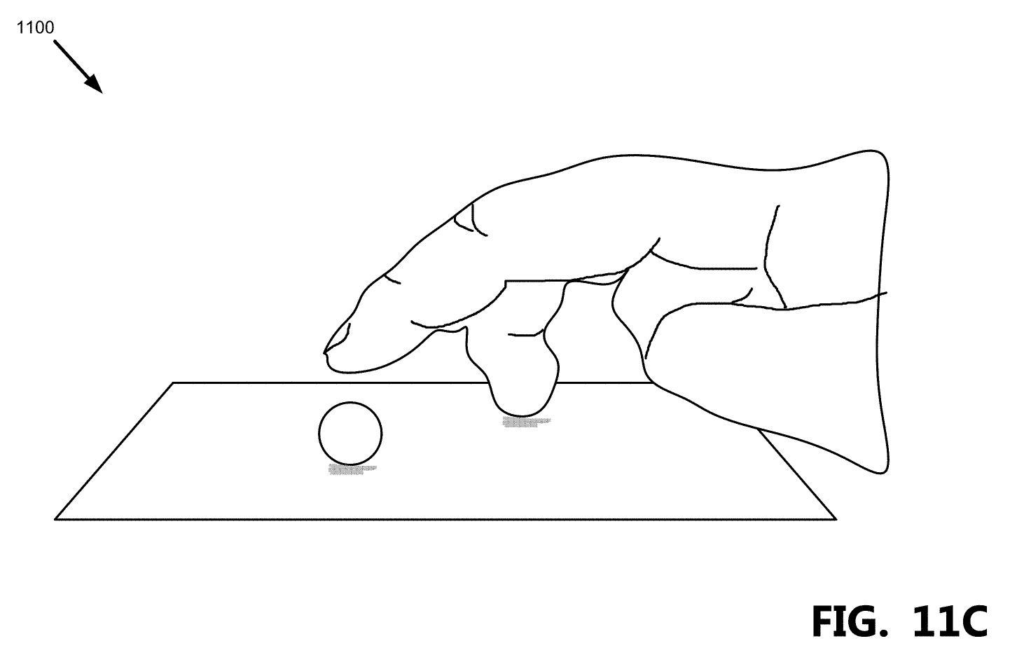

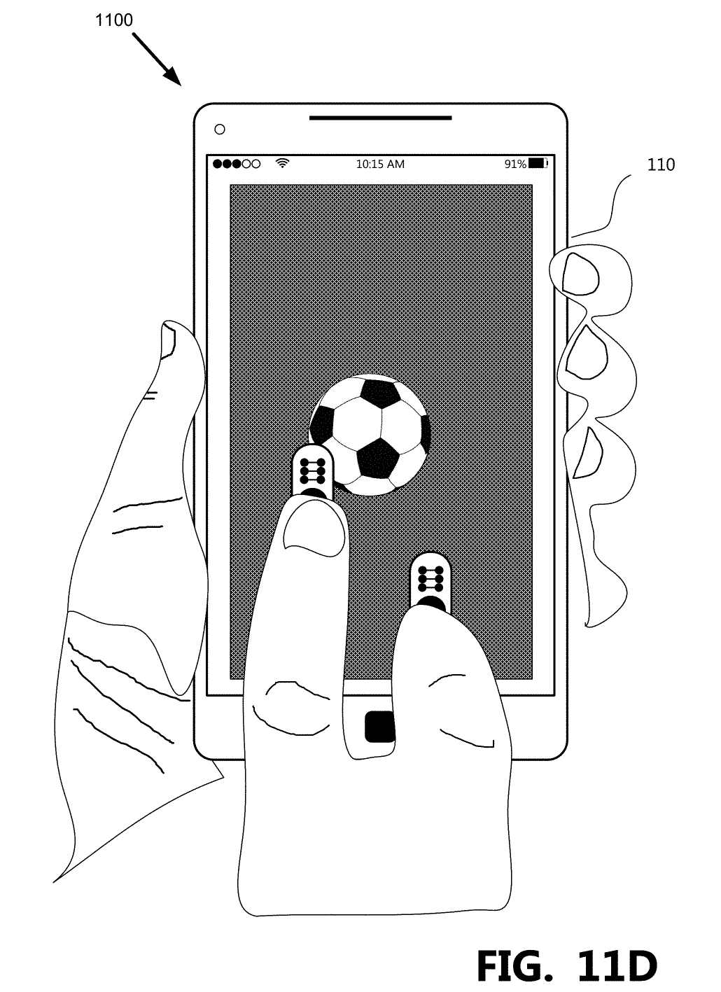

FIGS. 11A-11D are illustrations of example graphical user interfaces 1100 implementing pre-interaction context associated with gesture and touch interactions. More specifically, the pre-interaction context system 130 is operable to utilize hybrid touch+hover gestures. As illustrated in FIGS. 11A-11D, a soccer game illustrates the uses of hybrid touch+hover gestures. Based on the pre-interaction context, the pre-interaction context system 130 is able to distinguish whether the hover gesture interacts with the displayed content. For example, in FIGS. 11A-11B, one finger touches the touchscreen and the other finger strikes the ball. The trajectory of the kick depends on the direction of movement and how high (or low) to the touchscreen the user kicks. Alternatively, in FIGS. 11C-11D, the hover gesture can also be lifted above the ball to “step” on it, or to move over the ball. Additionally, the touch+hover gestures may be used to control an avatar or walking-in-place interactions for virtual navigation.

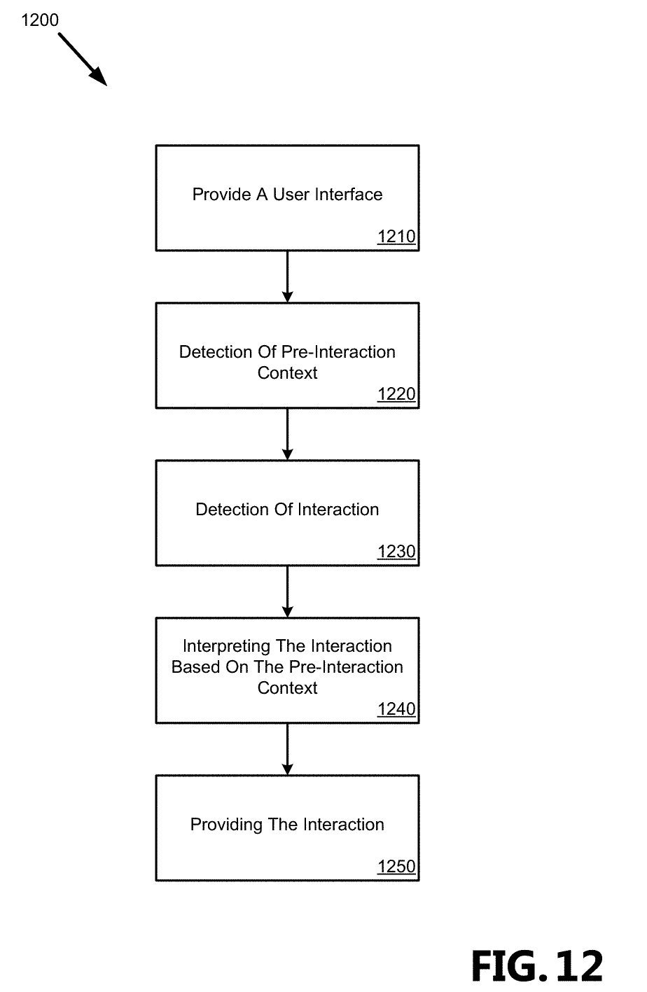

FIG. 12 is a flow chart showing general stages involved in an example method 1200 implementing pre-interaction context associated with gesture and touch interactions.

The method 1200 begins at start OPERATION 1210, where the computing device 110 provides a user interface on a touchscreen. Further, the computing device 110 includes a pre-interaction context system 130 configured to detect information prior to receiving a gesture or touch on the touchscreen. According to one aspect, the pre-interaction context is detected by capacitance values associated with a finger being proximate to the touchscreen.

The method 1200 continues to OPERATION 1220, where the pre-interaction context system 130 detects pre-interaction context. Upon detection of the pre-interaction context, the pre-interaction context system 130 captures the raw sensor data associated with the approach of the finger(s). The pre-interaction context system 130 interpolates the raw sensor data. Thereafter, a first threshold is applied to the interpolated sensor data to remove noise associated with the capacitance detection. Further, the pre-interaction context system 130 increases the contrast of the interpolated sensor data and applies a second threshold, which allows the fingertip region of the finger to be isolated. The fingertip region is used to identify the location of the fingertip by identifying the local maxima of the fingertip region 350. Further, the pre-interaction context system 130 is able to identify the orientation of the finger, the approach trajectory, and distinguish between whether the finger or thumb is being used for the interaction. In alternate examples, the pre-interaction context system 130 may utilize machine learning to identify the fingertip region.

The method 1200 continues to OPERATION 1230, where the pre-interaction context system 130 detects an interaction from the user.

The method 1200 continues to OPERATION 1240, where the pre-interaction context system interprets the interaction based on the pre-interaction context. The pre-interaction context system 130 uses the pre-interaction context for implementing anticipatory reactions, retroactive interpretations, and hybrid+touch gestures. In anticipatory reactions, the pre-interaction context system 130 is configured to modify the interface based on the approach of the fingers in a manner that furthermore may be contingent on grip. Further, the interface may be context-sensitive depending on the current grip, the approach trajectory, and the number of fingers. The pre-interaction context system 130 uses the pre-interaction context for implementing retroactive interpretations, which construe touch events based on the approach trajectory. Based on the approach trajectory, the pre-interaction context system 130 is configured to distinguish between ballistic taps and fine taps allowing on-contact discrimination between tap or drag events and flick-to-scroll vs. text selection. The pre-interaction context system 130 uses the pre-interaction context for implementing hybrid touch+hover gestures that combine on-screen touch with above-screen aspects, such as selecting an object with the thumb while bringing the index finger into range to interact with other functionality.

The method 1200 continues to OPERATION 1250, where the pre-interaction context system 130 provides the interaction on the user interface.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 13-15 and the associated descriptions provide a discussion of a variety of operating environments in which examples are practiced. However, the devices and systems illustrated and discussed with respect to FIGS. 13-15 are for purposes of example and illustration and are not limiting of a vast number of computing device configurations that are utilized for practicing aspects, described herein.

FIG. 13 is a block diagram illustrating physical components (i.e., hardware) of a computing device 1300 with which examples of the present disclosure may be practiced. In a basic configuration, the computing device 1300 includes at least one processing unit 1302 and a system memory 1304. According to an aspect, depending on the configuration and type of computing device, the system memory 1304 comprises, but is not limited to, volatile storage (e.g., random access memory), non-volatile storage (e.g., read-only memory), flash memory, or any combination of such memories. According to an aspect, the system memory 1304 includes an operating system 1305 and one or more program modules 1306 suitable for running software applications 1350. According to an aspect, the system memory 1304 includes the pre-interaction context system 130. The operating system 1305, for example, is suitable for controlling the operation of the computing device 1300. Furthermore, aspects are practiced in conjunction with a graphics library, other operating systems, or any other application program, and are not limited to any particular application or system. This basic configuration is illustrated in FIG. 13 by those components within a dashed line 1308. According to an aspect, the computing device 1300 has additional features or functionality. For example, according to an aspect, the computing device 1300 includes additional data storage devices (removable and/or non-removable) such as, for example, magnetic disks, optical disks, or tape. Such additional storage is illustrated in FIG. 13 by a removable storage device 1309 and a non-removable storage device 1310.

As stated above, according to an aspect, a number of program modules and data files are stored in the system memory 1304. While executing on the processing unit 1302, the program modules 1306 (e.g., the pre-interaction context system 130) perform processes including, but not limited to, one or more of the stages of the method 1200 illustrated in FIG. 12. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 13 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 1300 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 1300 has one or more input device(s) 1312 such as a keyboard, a mouse, a pen, a sound input device, a touch input device, etc. The output device(s) 1314 such as a display, speakers, a printer, etc. are also included according to an aspect. The aforementioned devices are examples and others may be used. According to an aspect, the computing device 1300 includes one or more communication connections 1316 allowing communications with other computing devices 1318. Examples of suitable communication connections 1316 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. According to an aspect, any such computer storage media is part of the computing device 1300. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

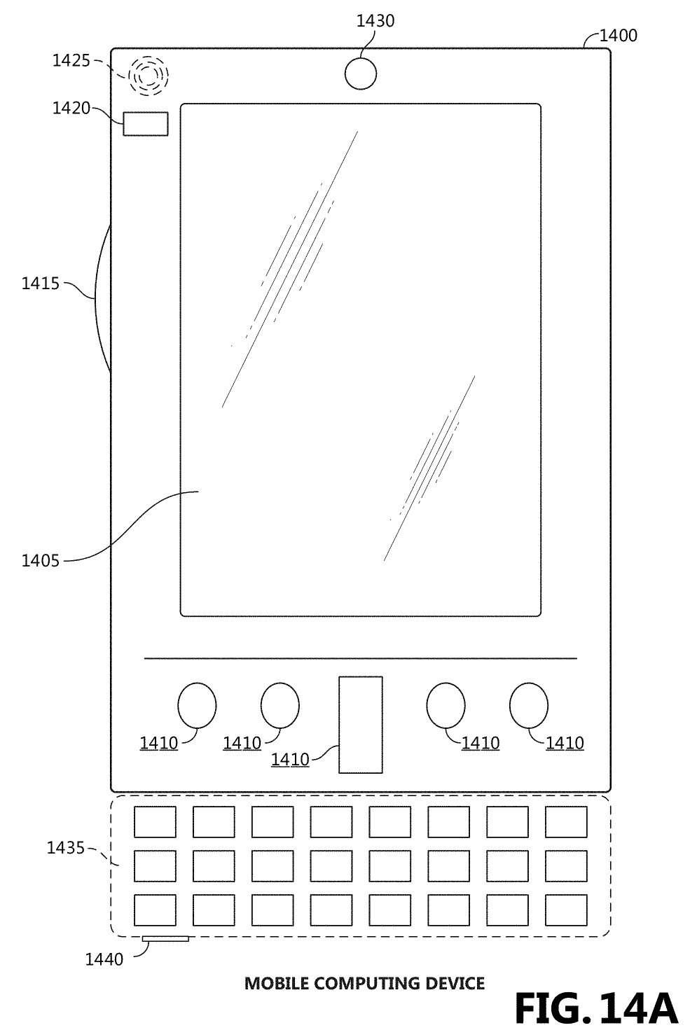

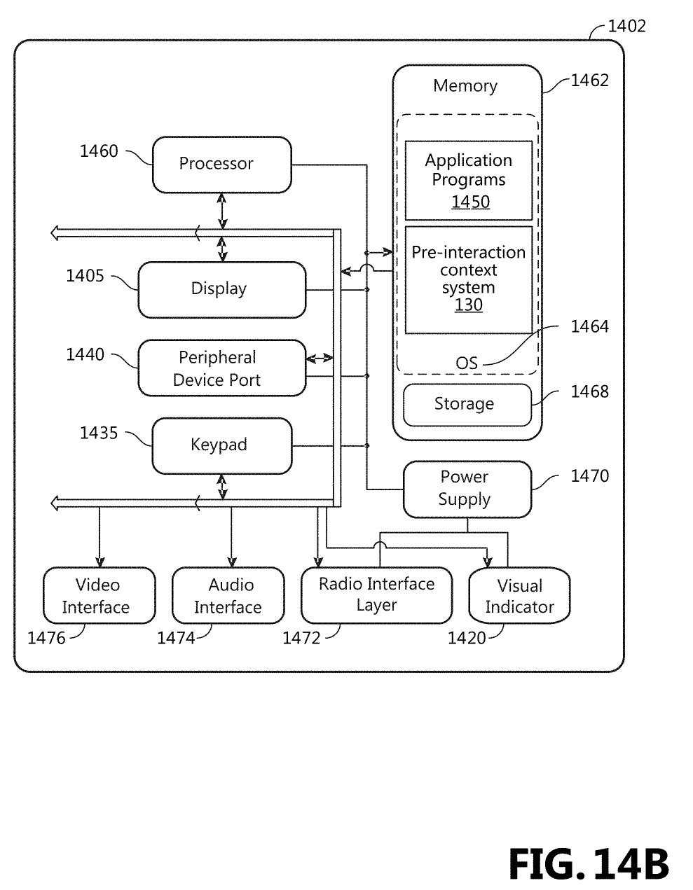

FIGS. 14A and 14B illustrate a mobile computing device 1400, for example, a mobile telephone, a smart phone, a tablet personal computer, a laptop computer, and the like, with which aspects may be practiced. With reference to FIG. 14A, an example of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. According to an aspect, the display 1405 of the mobile computing device 1400 functions as an input device (e.g., a touch screen display). If included, an optional side input element 1415 allows further user input. According to an aspect, the side input element 1415 is a rotary switch, a button, or any other type of manual input element. In alternative examples, mobile computing device 1400 incorporates more or fewer input elements. For example, the display 1405 may not be a touch screen in some examples. In alternative examples, the mobile computing device 1400 is a portable phone system, such as a cellular phone. According to an aspect, the mobile computing device 1400 includes an optional keypad 1435. According to an aspect, the optional keypad 1435 is a physical keypad. According to another aspect, the optional keypad 1435 is a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 1400 incorporates peripheral device port 1440, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 incorporates a system (i.e., an architecture) 1402 to implement some examples. In one example, the system 1402 is implemented as a “smart phone” capable of running one or more applications (e.g., browser, e-mail, calendaring, contact managers, messaging clients, games, and media clients/players). In some examples, the system 1402 is integrated as a computing device, such as an integrated personal digital assistant (PDA) and wireless phone.

According to an aspect, one or more application programs 1450 are loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, and so forth. According to an aspect, the pre-interaction context system 130 is loaded into memory 1462. The system 1402 also includes a non-volatile storage area 1468 within the memory 1462. The non-volatile storage area 1468 is used to store persistent information that should not be lost if the system 1402 is powered down. The application programs 1450 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400.

According to an aspect, the system 1402 has a power supply 1470, which is implemented as one or more batteries. According to an aspect, the power supply 1470 further includes an external power source, such as an AC adapter or a powered docking cradle that supplements or recharges the batteries.

According to an aspect, the system 1402 includes a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1450 via the operating system 1464, and vice versa.

According to an aspect, the visual indicator 1420 is used to provide visual notifications and/or an audio interface 1474 is used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. According to an aspect, the system 1402 further includes a video interface 1476 that enables an operation of an on-board camera 1430 to record still images, video stream, and the like.

According to an aspect, a mobile computing device 1400 implementing the system 1402 has additional features or functionality. For example, the mobile computing device 1400 includes additional data storage devices (removable and/or non-removable) such as, magnetic disks, optical disks, or tape. Such additional storage is illustrated in FIG. 14B by the non-volatile storage area 1468.

According to an aspect, data/information generated or captured by the mobile computing device 1400 and stored via the system 1402 are stored locally on the mobile computing device 1400, as described above. According to another aspect, the data are stored on any number of storage media that are accessible by the device via the radio 1472 or via a wired connection between the mobile computing device 1400 and a separate computing device associated with the mobile computing device 1400, for example, a server computer in a distributed computing network, such as the Internet. As should be appreciated such data/information are accessible via the mobile computing device 1400 via the radio 1472 or via a distributed computing network. Similarly, according to an aspect, such data/information are readily transferred between computing devices for storage and use according to well-known data/information transfer and storage means, including electronic mail and collaborative data/information sharing systems.

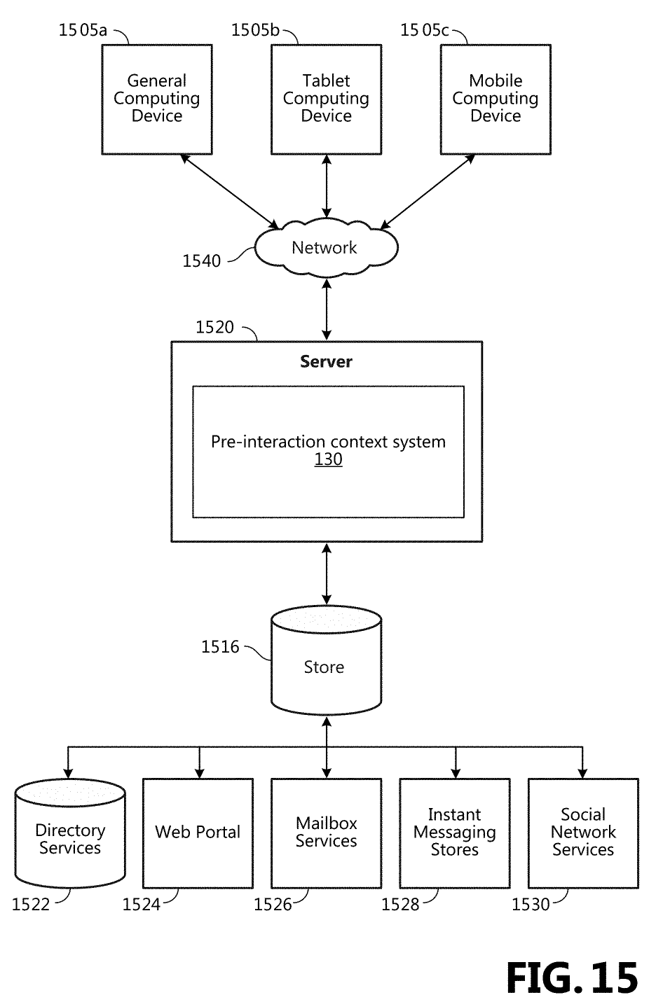

FIG. 15 illustrates one example of the architecture of a system for utilization of pre-interaction context as described above. Content developed, interacted with, or edited in association with the pre-interaction context system 130 is enabled to be stored in different communication channels or other storage types. For example, various documents may be stored using a directory service 1522, a web portal 1524, a mailbox service 1526, an instant messaging store 1528, or a social networking site 1530. The pre-interaction context system 130 is operative to use any of these types of systems or the like for utilization of pre-interaction context, as described herein. According to an aspect, a server 1520 provides the pre-interaction context system 130 to clients 1505a,b,c. As one example, the server 1520 is a web server providing the pre-interaction context system 130 over the web. The server 1520 provides the pre-interaction context system 130 over the web to clients 1505 through a network 1540. By way of example, the client computing device is implemented and embodied in a personal computer 1505a, a tablet computing device 1505b or a mobile computing device 1505c (e.g., a smart phone), or other computing device. Any of these examples of the client computing device are operable to obtain content from the store 1516.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for enabling pre-interaction context for touch and gestures, comprising:
providing a user interface;
detecting pre-interaction context;
detecting an interaction;
interpreting the interaction based on the pre-interaction context; and
providing the interaction on the user interface.

2. The method of claim 1, wherein the pre-interaction context is defined by capacitance values associated with a finger approaching the user interface.

3. The method of claim 2, further comprising:
capturing raw sensor data associated with the capacitance values;
interpolating the raw sensor data;
applying a first threshold to the interpolated raw sensor data to remove noise associated with the capacitance values;
increasing a contrast of the interpolated sensor data;
applying a second threshold to isolate a fingertip region; and
placing a bounding box around the fingertip region to identify an orientation of the finger providing the interaction.

4. The method of claim 1, wherein the interaction is detected via the interpolated sensor data prior to the finger coming into contact with the user interface.

5. The method of claim 1, wherein detecting the interaction further comprises:
identifying a first location of a first finger relative to the user interface;
identifying a second location of a second finger relative to the user interface; and
wherein the interaction is a multi-finger interaction.

6. The method of claim 5, wherein the multi-finger interaction is a pinch-to-zoom interaction, further comprising:
detecting a movement of the first location relative to the second location; and
in response to the movement, determining a zoom amount to apply as the interaction.

7. The method of claim 6, further comprising:
determining, based on the orientation of the finger and a position of the finger relative to the user interface, whether the finger is engaged in gripping the user interface; and
in response to determining that the finger is engaged in gripping the user interface, ignoring the interpolated sensor data associated with the finger.

8. The method of claim 7, wherein the interaction is detected via the interpolated sensor data with the finger temporarily losing contact with the user interface.

9. The method of claim 1, further comprising rotating the bounding box to include the fingertip region, wherein the angle of the bounding box identifies a trajectory of the pre-interaction context.

10. The method of claim 1, wherein interpreting the interaction based on the pre-interaction context further comprises identifying anticipatory reactions that modify the user interface based on the approach of the fingers.

11. The method of claim 1, wherein interpreting the interaction based on the pre-interaction context further comprises identifying retroactive interpretations that interpret touch events based on the approach trajectory and dynamic or contextual information associated with the computing device.

12. The method of claim 1, wherein interpreting the interaction based on the pre-interaction context further comprises identifying hybrid+touch gestures.

13. A computing device for pre-interaction context for touch and gestures, comprising:
a processing unit; and
a memory, including computer readable instructions, which when executed by the processing unit is operable to:
provide a user interface;
detect pre-interaction context;
detect an interaction;
interpret the interaction based on the pre-interaction context; and
provide the interaction on the user interface.

14. The computing device of claim 13, wherein the processing unit is further operable to:
capture raw sensor data including capacitance values associated with approach of the interaction;
interpolate the raw sensor data;
apply a first threshold to the interpolated raw sensor data to remove noise associated with the capacitance values;
increase the contrast of the interpolated sensor data and apply a second threshold to isolate the fingertip region; and
identify the location of a fingertip by identifying the local maxima of the fingertip region.

15. The computing device of claim 13, the processing unit further operable to place a bounding box around the fingertip region to identify the orientation of the finger.

16. The computing device of claim 13, wherein the bounding box is rotated to include the fingertip region, wherein the angle of the bounding box identifies a trajectory of the pre-interaction context.

17. The computing device of claim 13, wherein the processing unit further operable to interpret the interaction based on the pre-interaction context by identifying anticipatory reactions that modifies the user interface based on the approach of the fingers.

18. The computing device of claim 13, wherein the processing unit further operable to interpret the interaction based on the pre-interaction context by identifying retroactive interpretations that construe touch events based on the approach trajectory.

19. The computing device of claim 13, wherein the processing unit further operable to interpret the interaction based on the pre-interaction context by identifying hybrid+touch gestures.

20. A computer readable storage device including computer readable instructions, which when executed by a processing unit is operable to perform the method of:
providing a user interface;
detecting pre-interaction context, including capturing raw sensor data including capacitance values associated with approach of the interaction, interpolating the raw sensor data, applying a first threshold to the interpolated raw sensor data to remove noise associated with the capacitance values, increasing the contrast of the interpolated sensor data and apply a second threshold to isolate the fingertip region, and identifying the location of a fingertip by identifying the local maxima of the fingertip region;
detecting an interaction;
interpreting the interaction based on the pre-interaction context; and
providing the interaction on the user interface.
